(19) United States
(12) Patent Application Publication
(10) Pub. No.: US 2024/0283897 A1
(43) Pub. Date: Aug. 22, 2024

(54) 3D IMAGE MASK ANALYSIS METHOD AND RELATED IMAGE SURVEILLANCE APPARATUS

(71) Applicant: VIVOTEK INC., New Taipei City (TW)

(72) Inventor: Chao-Tan Huang, New Taipei City (TW)

(73) Assignee: VIVOTEK INC., New Taipei City (TW)

(21) Appl. No.: 18/418,375

(22) Filed: Jan. 22, 2024

(30) Foreign Application Priority Data
Feb. 16, 2023 (TW) 112105487

(51) Int. Cl. H04N 7/18; G06T 7/13; G06T 7/50; G06T 7/60; G06T 7/73; G06V 20/52

(52) U.S. Cl. CPC H04N 7/183; G06T 7/13; G06T 7/50; G06T 7/60; G06T 7/73; G06V 20/52; G06T 2207/20021; G06T 2207/20084; G06T 2207/30232; G06T 2207/30242

(57) ABSTRACT

A 3D image mask analysis method is applied to an image surveillance apparatus having an image receiver and an operation processor. The 3D image mask analysis method includes establishing a 3D image mask with first depth information inside a surveillance image acquired by the image receiver, utilizing an object identification technology to acquire second depth information of a target object at least partly overlapped with the 3D image mask inside the surveillance image, and comparing the first depth information to the second depth information so as to determine whether an image of the target object is displayed inside the surveillance image in accordance with a comparison result.

### BACKGROUND OF THE INVENTION

### 1. Field of the Invention

The present invention relates to a 3D image mask analysis method and a related image surveillance apparatus, and more particularly, to a 3D image mask analysis method of determining whether to display the target object via analysis of the depth information and a related image surveillance apparatus.

### 2. Description of the Prior Art

The image surveillance apparatus is often used in the public place, and may inevitably capture images of the specific area with privacy concerns, such as the door or the window of the private building. The conventional image surveillance apparatus can set an image mask on the range overlapped with the specific area within the surveillance image, and the display screen does not display the target object under the image mask. However, if the image mask is set on the entrance of the building, the conventional image surveillance apparatus cannot identify whether the target object is located inside or outside the building. The target object located at the entrance and inside the building should be sheltered by the image mask; the target object located at the entrance and outside the building is in the public place, but the conventional image surveillance apparatus may misjudge and shelter the target object by the image mask. Therefore, design of an image mask analysis method of identifying depth information and determining whether to display the target object is an important issue in the related surveillance industry.

### SUMMARY OF THE INVENTION

The present invention provides a 3D image mask analysis method of determining whether to display the target object via analysis of the depth information and a related image surveillance apparatus for solving above drawbacks.

According to the claimed invention, a 3D image mask analysis method is applied to an image surveillance apparatus having an image receiver and an operation processor. The 3D image mask analysis method includes setting a 3D image mask with first depth information inside a surveillance image acquired by the image receiver, utilizing an object identification technology to acquire second depth information of a target object at least partly overlapped with the 3D image mask inside the surveillance image, and comparing the first depth information with the second depth information to determine whether an image of the target object is displayed inside the surveillance image in accordance with a comparison result.

According to the claimed invention, an image surveillance apparatus includes an image receiver and an operation processor. The image receiver is adapted to acquire a surveillance image. The operation processor is electrically connected with the image receiver. The operation processor is adapted to set a 3D image mask with first depth information inside the surveillance image, utilize an object identification technology to acquire second depth information of a target object at least partly overlapped with the 3D image mask inside the surveillance image, and compare the first depth information with the second depth information to determine whether an image of the target object is displayed inside the surveillance image in accordance with a comparison result.

The 3D image mask analysis method and the image surveillance apparatus of the present invention can set the 3D image mask on the surveillance image to shelter the specific area with the privacy concerns, and further compute and compare the first depth information of the 3D image mask with the second depth information of the target object to determine whether the target object is in front of or behind the 3D image mask, so as to determine whether the image of the target object is displayed on the surveillance image. Comparing to the prior art, the 3D image mask analysis method and the image surveillance apparatus of the present invention can provide the setting and analyzing process of the 3D image mask, to rapidly identify the relative depth relation between the target object and the 3D image mask for effectively improving image identification accuracy.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image surveillance apparatus according to an embodiment of the present invention.

FIG. 2 is a diagram of a scene where on the image surveillance apparatus is disposed according to the embodiment of the present invention.

FIG. 3 is a diagram of a surveillance image acquired by the image surveillance apparatus according to the embodiment of the present invention.

FIG. 4 is a flow chart of a 3D image mask analysis method according to the embodiment of the present invention.

FIG. 5 and FIG. 6 are diagrams of the surveillance image in different situations according to the embodiment of the present invention.

FIG. 7 is a diagram of the surveillance image according to another embodiment of the present invention.

FIG. 8 to FIG. 10 are diagrams of operation of the 3D image mask according to different embodiments of the present invention.

### DETAILED DESCRIPTION

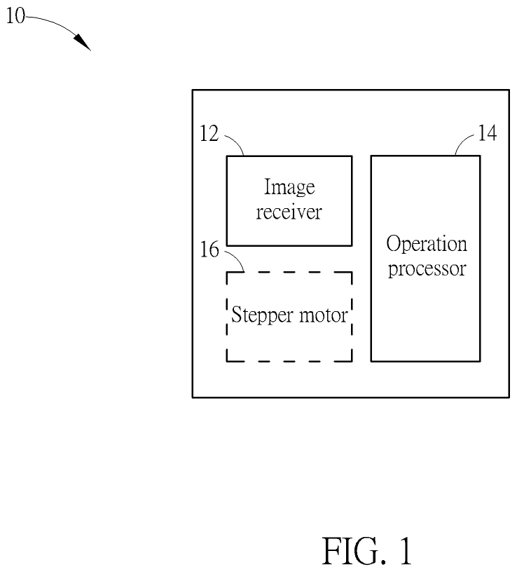

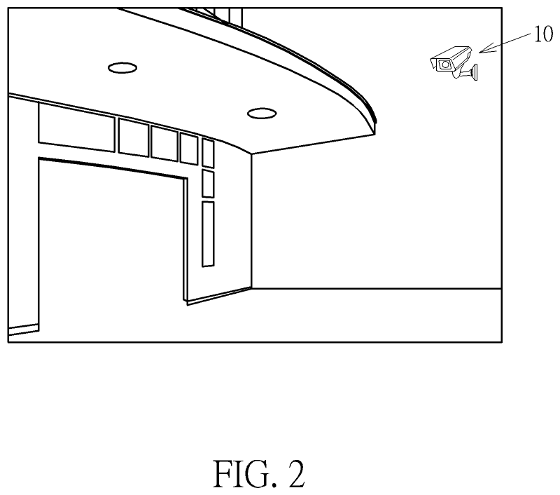

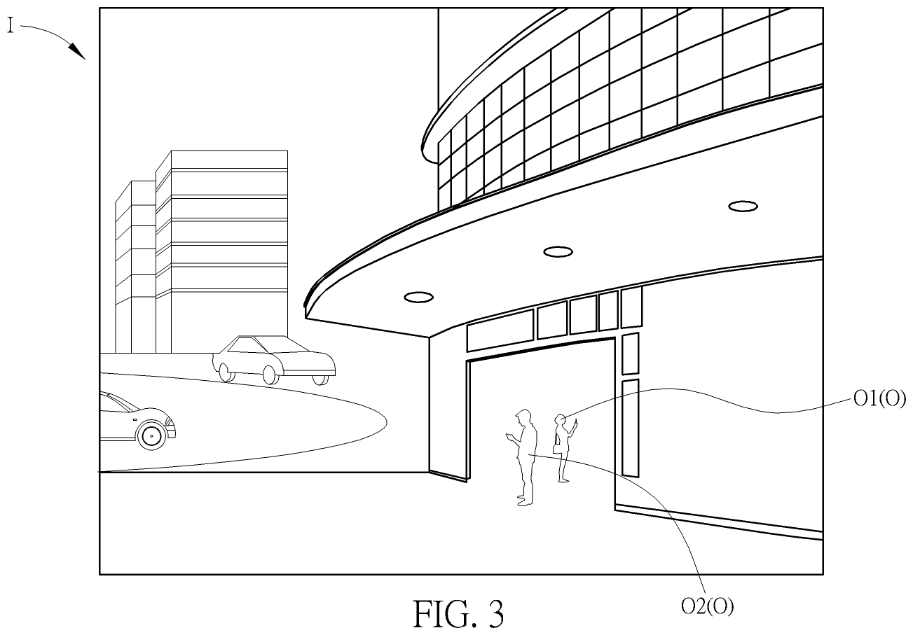

Please refer to FIG. 1 to FIG. 3. FIG. 1 is a functional block diagram of an image surveillance apparatus 10 according to an embodiment of the present invention. FIG. 2 is a diagram of a scene where on the image surveillance apparatus 10 is disposed according to the embodiment of the present invention. FIG. 3 is a diagram of a surveillance image I acquired by the image surveillance apparatus 10 according to the embodiment of the present invention. The image surveillance apparatus 10 can include an image receiver 12 and an operation processor 14 electrically connected with each other. The image receiver 12 can be a camera adapted to directly capture the surveillance image I, or can be a signal receiver used to receive the surveillance image I captured by an external camera. The operation processor 14 can be a built-in processing unit of the image receiver 12, or a processing unit independent from the image receiver 12. Application of the image receiver 12 and the operation processor 14 can depend on a design demand, and a detailed description is omitted herein for simplicity.

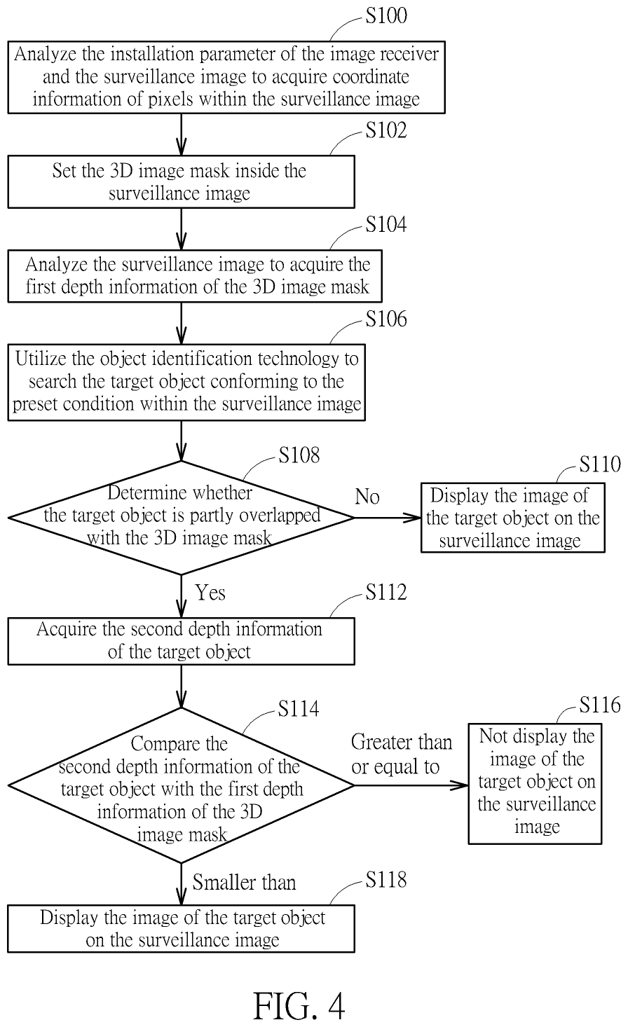

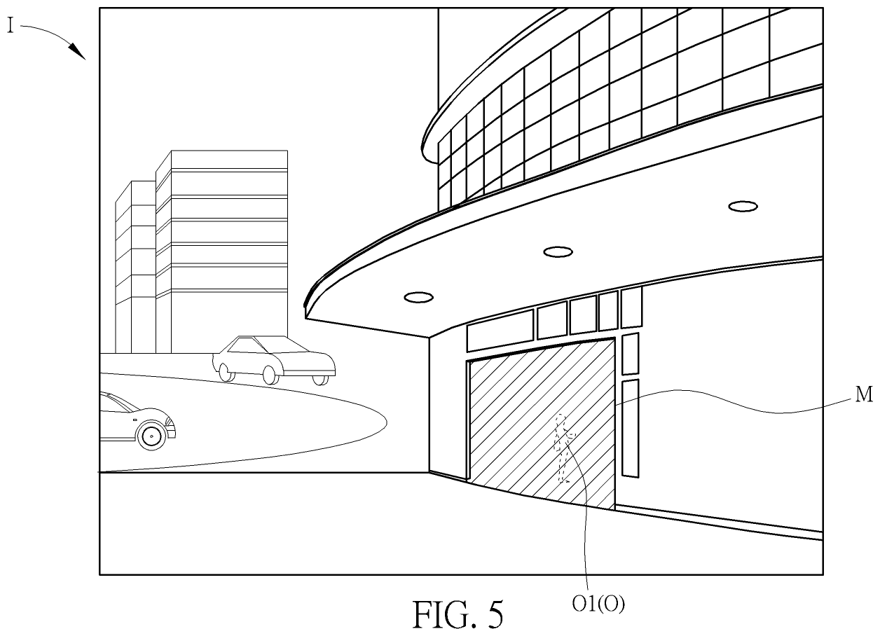

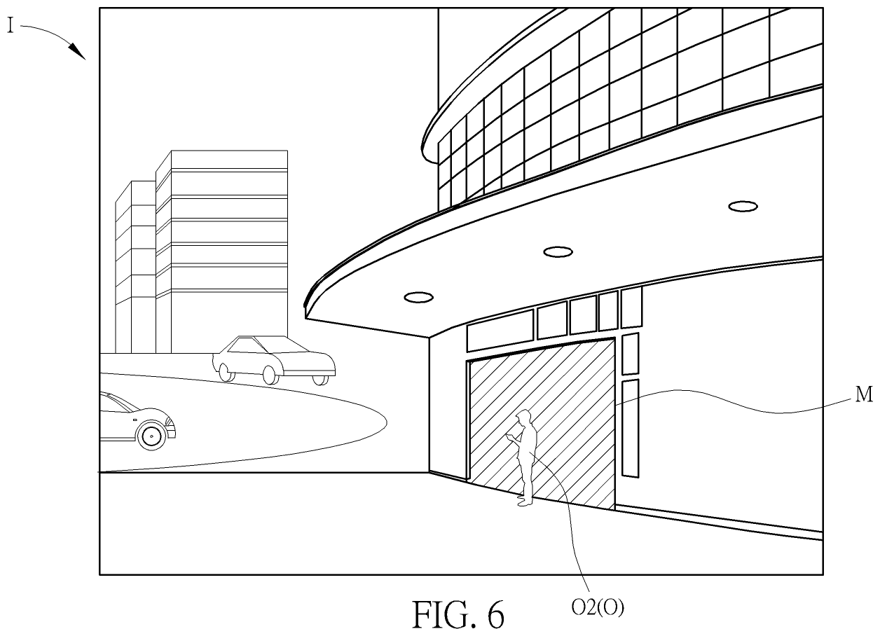

Please refer to FIG. 4 to FIG. 6. FIG. 4 is a flow chart of a 3D image mask analysis method according to the embodiment of the present invention. FIG. 5 and FIG. 6 are diagrams of the surveillance image I in different situations according to the embodiment of the present invention. The 3D image mask analysis method illustrated in FIG. 4 can be suitable for the image surveillance apparatus 10 shown in FIG. 1 to FIG. 3. In the 3D image mask analysis method, step S100 can be executed to analyze an installation parameter of the image receiver 12 and the surveillance image I acquired by the image receiver 12, so as to acquire coordinate information of each pixel of the surveillance image I. The foresaid coordinate information can be interpreted as two-dimensional (2D) coordinate information on the surveillance image I and three-dimensional (3D) coordinate information of a surveillance range covered by the surveillance image I in a real world. Computation of the 2D coordinate information and the 3D coordinate information can depend on common coordinate conversion functions, and the detailed description is omitted herein for simplicity. The installation parameter can be an installation height of the image surveillance apparatus 10 relative to the ground, an included angle of the lens of the image surveillance apparatus 10 relative to a normal vector of the ground, and any available parameters.

Then, step S102 and step S104 can be executed to set a 3D image mask M inside the surveillance image I, and analyze some of the coordinate information of all pixels within the surveillance image I that are relevant to the 3D image mask M, for acquiring first depth information of the 3D image mask M. Generally, the 3D image mask M can be used to shelter a specific area of the surveillance range with privacy concerns, such as the door or the window of the building, or any entrance or exit that does not allow peep. Taking an example shown in FIG. 3, the building can be displayed in the surveillance image I, and the outside of the building's door belongs to a public place, so the image surveillance apparatus 10 can detect and compute a number of people in the public place; however, the space inside the building is a private area, and the building's owner may not allow activity inside the building being peeped, so that the image surveillance apparatus 10 can set the 3D image mask M on the door of the building to prevent the activity of people inside the door from being detected. The 3D image mask M may be manually set by a user, or be automatically set by the image surveillance apparatus 10 via any available identification technology; application of the 3D image mask M can depend on an actual demand. A setting manner of the 3D image mask M will be illustrated as following description.

In step S104, the image surveillance apparatus 10 can find out 2D coordinate information about a coverage range of the 3D image mask M within the surveillance image I in accordance with position of the 3D image mask M inside the surveillance image I, and utilize the foresaid coordinate conversion functions to transform the 2D coordinate information of the 3D image mask M into 3D coordinate information, so as to acquire the first depth information of the 3D image mask M via the 3D coordinate information. In other words, the first depth information can be interpreted as a distance of the 3D image mask M relative to the image surveillance apparatus 10 in the real world.

Then, step S106 can be executed to utilize an object identification technology to search a target object O conforming to a preset condition within the surveillance image I. the foresaid preset condition can be designed in accordance with the actual demand of the image surveillance apparatus 10. For example, the preset condition may be a vehicle model or a human type, and the image surveillance apparatus 10 can count the number of vehicles or persons in accordance with the actual demand; further, the preset condition may be human gender, and the image surveillance apparatus 10 can classify and count the gender or any possible feature of persons. Then, step S108 can be executed to determine whether the target object O is partly overlapped with the 3D image mask M. If the target object O is not partly overlapped with the 3D image mask M, the target object O may be indicated as staying in the public place, and step S110 can be executed to directly display the image of the target object O on the surveillance image I. If the target object O is partly overlapped with the 3D image mask M, the target object O may be indicated as staying in the public place or in the private area, and step S112 can be executed to acquire second depth information of the target object O. For example, the 2D coordinate information of the target object O within the surveillance image I can be found out, and the bottom coordinates of the target object O is located on the ground and therefore the related height should be zero, so that the 3D coordinate information in the real world can be computed via the foresaid coordinate conversion functions for acquiring the second depth information.

Then, step S114 can be executed to compare the second depth information of the target object O with the first depth information of the 3D image mask M. If the second depth information is greater than or equal to the first depth information, the target object O may stay in the building, and step S116 can be executed to not display the image of the target object O on the surveillance image I; as shown in FIG. 5, the target object O1 is in the building, and the image of the target object O1 can be sheltered by the 3D image mask M. The dotted contour of the target object O1 is displayed in FIG. 5 for explanation, and actual application is that the target object O1 is completely sheltered by the 3D image mask M. If the second depth information I is smaller than the first depth information, the target object O may be outside the building, and step S118 can be executed to display the image of the target object O on the surveillance image I, such as the target object O2 shown in FIG. 6. The place around the contour of the target object O2 may still belong to the private area inside the door of the building, and can be still sheltered by the 3D image mask M.

In step S118, the 3D image mask analysis method can acquire object coordinate information of several pixels contained by the contour of the target object O2 within the surveillance image I, and the foresaid object coordinate information may be the 2D coordinate information; then, mask pixel information of the 3D image mask M that is overlapped with the object coordinate information of the target object O2 can be found out, and the foresaid mask pixel information can be replaced with object pixel information of some pixels contained by the contour of the target object O2, and therefore the image of the target object O2 can be displayed over the 3D image mask M within the surveillance image I. For example, the mask pixel information of the 3D image mask M may be a diagonal-line pattern or a color block with specific color, and any type of the 3D image mask M that can shelter a real image of the target object O can conform to a design scope of the present invention. The object coordinate information of the several pixels contained by the contour of the target object O2 can depend on an overlapped range between the 3D image mask M and the target object O2; as shown in FIG. 6, the object coordinate information of the target object O2 can be the head and the upper body of the pedestrian, and the object pixel information of the target object O2 can be images of the head and the upper body of the pedestrian.

It should be mentioned that the present invention may not determine whether the target object O is partly overlapped with the 3D image mask M via step S108, and can use other method to determine position relation between the target object O and the 3D image mask M. For example, the present invention can optionally compute the second depth information of the target object O1 and the target object O2 and then compare with the first depth information of the 3D image mask M; if the second depth information of the target object O1 or the target object O2 is smaller than the first depth information of the 3D image mask M, the target object O1 or the target object O2 can be more close to the image surveillance apparatus 10 than the 3D image mask M, and therefore the present invention can display the image of the target object O1 or the target object O2 on the surveillance image I.

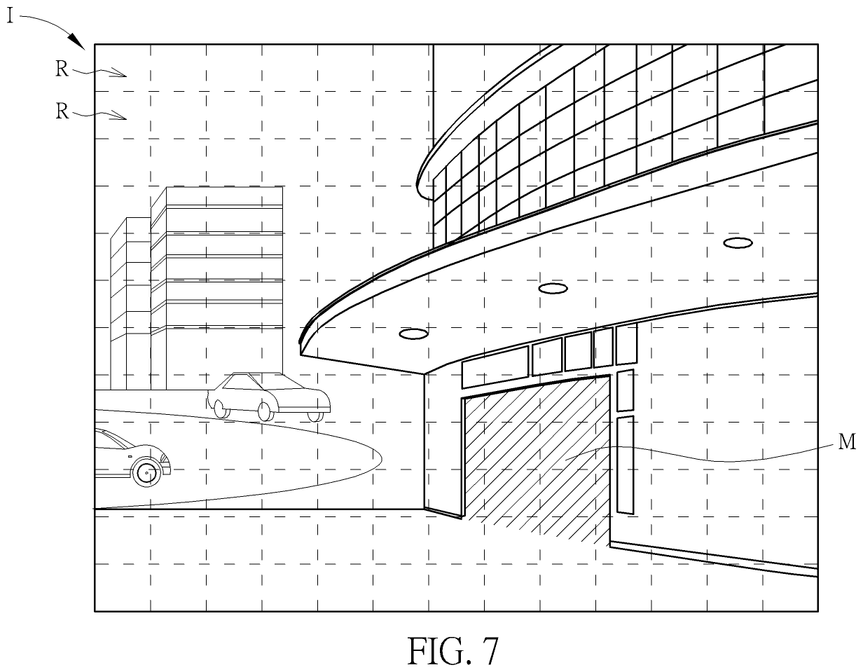

The preferred embodiment of the present invention can utilize the coordinate conversion functions of the 2D coordinate information and the 3D coordinate information of the surveillance image I to acquire the first depth information of the 3D image mask M and the second depth information of the target object O within the surveillance image I; however, practical application is not limited to the foresaid manner. Please refer to FIG. 3 and FIG. 7. FIG. 7 is a diagram of the surveillance image I according to another embodiment of the present invention. In other possible embodiment, the image surveillance apparatus 10 can include a stepper motor 16 used to control focusing steps of the image receiver 12, for adjusting focus plane of imaging position. The 3D image mask analysis method of the present invention can divide the surveillance image I into a plurality of areas R, and the stepper motor 16 can control the image receiver 12 to respectively focus on all the areas R of the surveillance image I, so as to analyze and acquire the focusing step of each area R in a clearest condition. The plurality of focusing steps of the plurality of areas R can be used to compute an object distance of each area R relative to the image surveillance apparatus 10 in the real world, which can be interpreted as the depth information of all the areas R.

Therefore, the 3D image mask analysis method of the present invention can search some of the plurality of areas R within the surveillance image I that is relevant to the 3D image mask M, and compute the object distance of the 3D image mask M relative to the image surveillance apparatus 10 via the focusing steps of the searched areas R; the computed object distance can be interpreted as the first depth information. Accordingly, the 3D image mask analysis method of the present invention can utilize the object identification technology to identify the target object O inside the surveillance image I, and then can compute the object distance of the target object O relative to the image surveillance apparatus 10 in the real world in accordance with the focusing step of the corresponding area R that is relevant to the image of the target object O within the surveillance image I. As if the focusing steps (or can be interpreted as the object distance relative to the image surveillance apparatus 10 in the real world) of the 3D image mask M and the target object O are known, the foresaid focusing steps can be compared with each other to determine whether the target object O is in front of or behind the 3D image mask M.

Besides, the 3D image mask analysis method of the present invention can further utilize the object identification technology to acquire the height information of the target object O; the foresaid height information can be a number of pixels of the image of the target object O within the surveillance image I, or the pixel per feet (PPF) of the image of the target object O within the surveillance image I; application of the height information can depend on the design demand, and the detailed description is omitted herein for simplicity. In some situation, the target object O may be close to the 3D image mask M, such as staying beside the door of the building; further, the bottom of the target object O may be not located on the ground, such as stepping on the cabinet. Comparison of the first depth information of the 3D image mask M and the second depth information of the target object O may be difficult to identify an accurate position of the target object O, so that the height information of the target object O can be further compared with a preset height threshold. If a difference between the first depth information and the second depth information is smaller than the preset depth threshold, and the height information is greater than or equal to the preset height threshold, the target object O may be close to the door of the building, and the target object O may have the taller height and should be located in front of the 3D image mask M to be close to the image surveillance apparatus 10, and therefore the image of the target object O can be displayed on the surveillance image I.

The image surveillance apparatus 10 can utilize the neural network to acquire the 3D coordinate information of the target object O and/or the 3D image mask M, or the depth information of the target object O and/or the 3D image mask M relative to the image surveillance apparatus 10. In the neural network application, one or some surveillance images I can be analyzed to acquire the relative or absolute 3D coordinate information or the relative or absolute depth information within the surveillance image I. In the related skill, when the 3D image mask M is set within the surveillance image I, the corresponding 3D coordinate information or the corresponding depth information of areas where on the target object O is located within the surveillance image I can be compared to set the relative 3D image mask M, for being different from the coordinate information in the real world due to the foresaid manner, so that the present invention can utilize the 3D coordinate information or the depth information relative to the real world to set the 3D image mask M and to determine position of the target object O; that is, a coordinate system C′ of the present invention and a coordinate system C in the real world can be applied to the following formula 1:

$$C = f * {C}^{′} \qquad Formula 1$$

A parameter of “f” can be a conversion function, such as a constant value, a linear function, or a matrix. In this manner, the absolute position of the coordinate information is unnecessary, and the 3D image mask M can be analyzed only by the relative position (or the depth information) of the coordinate information. The position of an interest object or the target object O can be output by the neural network, and can be further acquired by computation or any known manners.

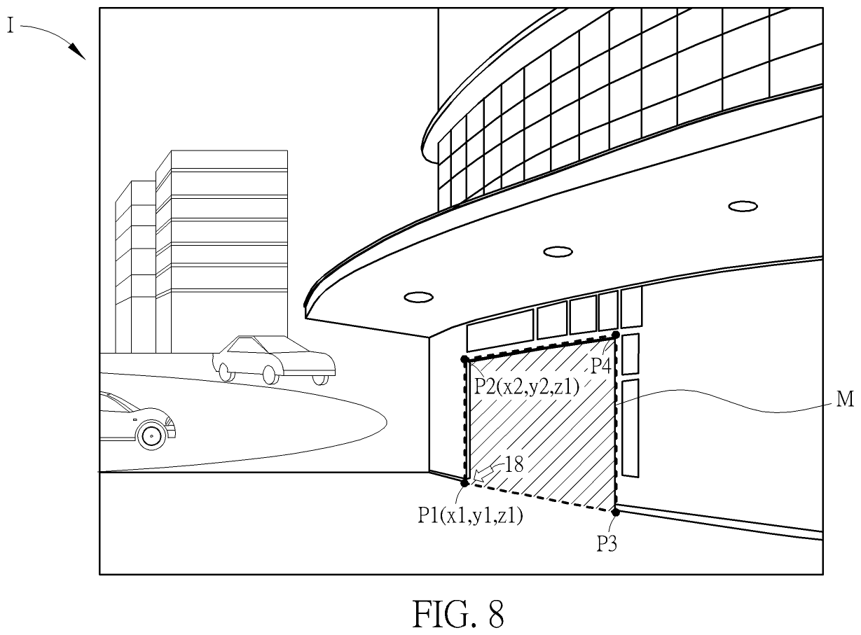

The present invention can provide several manners to set the 3D image mask M within the 2D surveillance image I via execution of step S102. Please refer to FIG. 8 to FIG. 10. FIG. 8 to FIG. 10 are diagrams of operation of the 3D image mask M according to different embodiments of the present invention. As shown in FIG. 8, the first manner can utilize an operation interface (such as a mouse) to manually mark a first position point P1 on the bottom of the 3D image mask M within the surveillance image I by the cursor 18 to acquire the first 3D coordinate information, such as values of “(x1, y1, z1)”; then, the first manner can further manually mark a second position point P2 on the top of the 3D image mask M by the cursor 18 to acquire the second 3D coordinate information, such as values of “(x2, y2, z1)”. The two position points marked by the cursor 18 on the surveillance image I can be initially defined as being located on the ground or the same step in the real world, and the heights in Z-axis of the first 3D coordinate information and the second 3D coordinate information can be zero or the same value.

However, the two points are marked because the second position point P2 is directly above the first position point P1, a connection line between the first position point P1 and the second position point P2 can belong to a straight border (which is drawn as a dotted line) of the 3D image mask M, so that the 3D image mask analysis method can utilize the first plane coordinate information (which means the values of “(x1, y1)”) of the first 3D coordinate information to replace the second plane coordinate information (which means the values of “(x2, y2)”) of the second 3D coordinate information, and further utilize the foresaid coordinate conversion functions about the 2D coordinate information and the 3D coordinate information of the surveillance image I to calibrate height coordinate information of the second 3D coordinate information, so as to acquire calibrated second 3D coordinate information; for example, the values of “(x2, y2, z1)” can be calibrated as the values of “(x1, y1, z1′)”. A difference between the height coordinate information z1′ and z1 can be defined as a height difference between the first position point P1 and the second position point P2 in the real world. The 3D coordinate information of a third position point P3 and a fourth position point P4 can be acquired by the same manners of the first position point P1 and the second position point P2, and therefore the 3D image mask M can be set within the surveillance image I.

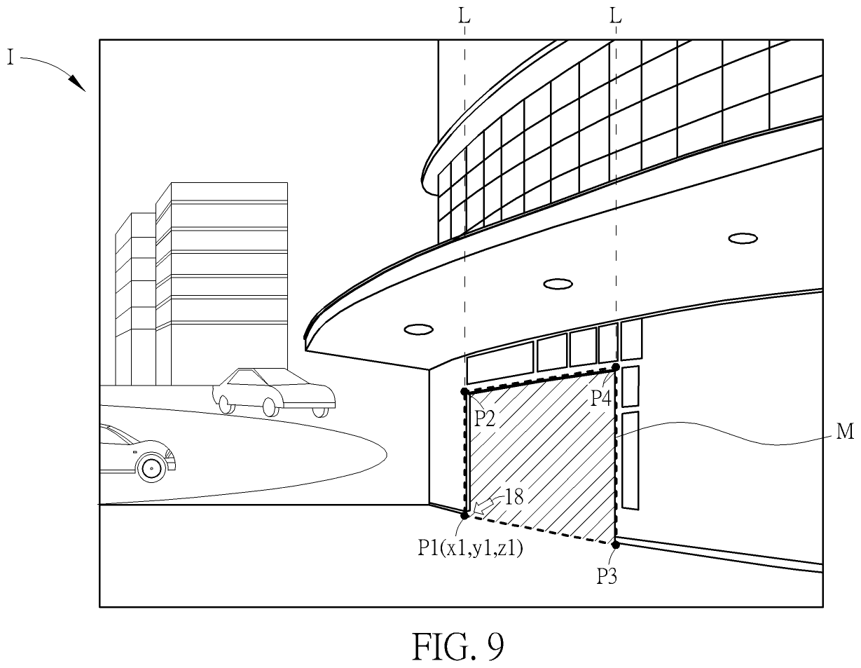

As shown in FIG. 9, the second manner can utilize the operation interface to mark the first position point P1 on the bottom of the 3D image mask M within the surveillance image I by the cursor 18 to acquire the first 3D coordinate information, such as the values of “(x1, y1, z1)”; then, the image surveillance apparatus 10 can generate a virtual auxiliary line L upwardly extended from the first position point P1. The second position point P2 can be marked on the virtual auxiliary line L via the operation interface in accordance with the actual demand; the connection line between the first position point P1 and the second position point P2 can be defined as the straight border of the 3D image mask M, and the 3D coordinate information of the third position point P3 and the fourth position point P4 can be acquired by the same manners of the first position point P1 and the second position point P2, and then the 3D image mask M can be set within the surveillance image I.

In the second manner, the first 3D coordinate information (x1, y1, z1) can be known information when the first position point P1 is marked, so that plane coordinate information of each pixel of the virtual auxiliary line L can be the same as first plane coordinate information (x1, y1) of the first 3D coordinate information, and the height coordinate information of each pixel of the virtual auxiliary line L can be defined as values of “(z1+n)”; a parameter “n” can be a vertical distance of each position point on the virtual auxiliary line L relative to the first position point P1. The foresaid process can be computed by the coordinate conversion functions about the 2D coordinate information and the 3D coordinate information of the surveillance image I. Thus, the image surveillance apparatus 10 can utilize the cursor 18 to mark the second position point P2 on the virtual auxiliary line L for immediately acquiring the second 3D coordinate information of the second position point P2.

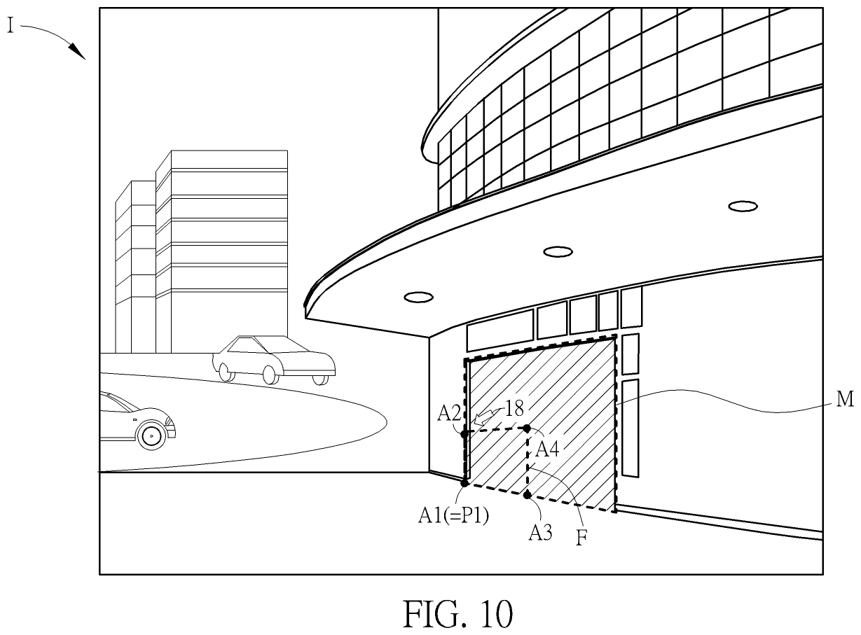

As shown in FIG. 10, the third manner can preset an auxiliary box F with a known size, such as 100×150 pixels, and an actual size of the auxiliary box F can depend on the size of the surveillance image I and the design demand. The image surveillance apparatus 10 can utilize the cursor 18 to mark the first position point P1 on the bottom of the 3D image mask M within the surveillance image I, and the first position point P1 can be indicated as a first corner point A1 of the auxiliary box F. Because the auxiliary box F has the known size, the image surveillance apparatus 10 can generate other corner points of the auxiliary box F optionally and automatically, such as a second corner point A2, a third corner point A3 and a fourth corner point A4. The foresaid embodiment takes the auxiliary box F with a quadrilateral shape as an example, but the actual application is not limited to the embodiment. If the auxiliary box F is designed as a triangle shape, the image surveillance apparatus 10 can generate the second corner point A2 and the third corner point A3 of the auxiliary box F accordingly when the first position point P1 is marked.

Then, the image surveillance apparatus 10 can adjust the coordinate information of the second corner point A2, the third corner point A3 and/or the fourth corner point A4 in accordance with the input command from the operation interface. The second corner point A2 can be directly above the first corner point A1; when the second corner point A2 is upwardly moved, the plane coordinate information of the second corner point A2 can be the same as the plane coordinate information of the first corner point A1 (or the first position point P1), and the height coordinate information of the second corner point A2 can correspond to a moving distance of the input command or the cursor 18. The third corner point A3 and the first corner point A1 can be set on the same plane; when the third corner point A3 is laterally moved, the height coordinate information of the third corner point A3 can be the same as the height coordinate information of the first corner point A1 (or the first position point P1), and the plane coordinate information of the third corner point A3 can correspond to the moving distance of the input command or the cursor 18. The fourth corner point A4 can be adjusted based on the third corner point A3, and its adjustment manner can be similar to relation between the first corner point A1 and the second corner point A2. Therefore, the 3D image mask analysis method can move the coordinate information of the second corner point A2, the third corner point A3 and the fourth corner point A4, to change the coverage range of the auxiliary box F for defining the 3D image mask M.

In conclusion, the 3D image mask analysis method and the image surveillance apparatus of the present invention can set the 3D image mask on the surveillance image to shelter the specific area with the privacy concerns, and further compute and compare the first depth information of the 3D image mask with the second depth information of the target object to determine whether the target object is in front of or behind the 3D image mask, so as to determine whether the image of the target object is displayed on the surveillance image. Comparing to the prior art, the 3D image mask analysis method and the image surveillance apparatus of the present invention can provide the setting and analyzing process of the 3D image mask, to rapidly identify the relative depth relation between the target object and the 3D image mask for effectively improving image identification accuracy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A 3D image mask analysis method applied to an image surveillance apparatus having an image receiver and an operation processor, the 3D image mask analysis method comprising:
the operation processor setting a 3D image mask with first depth information inside a surveillance image acquired by the image receiver;
the operation processor utilizing an object identification technology to acquire second depth information of a target object at least partly overlapped with the 3D image mask inside the surveillance image; and
the operation processor comparing the first depth information with the second depth information to determine whether an image of the target object is displayed inside the surveillance image in accordance with a comparison result.

2. The 3D image mask analysis method of claim 1, further comprising:
the operation processor analyzing at least one installation parameter of the image receiver to acquire coordinate information of each pixel within the surveillance image; and
the operation processor analyzing some of the coordinate information relevant to the 3D image mask for acquiring the first depth information.

3. The 3D image mask analysis method of claim 1, wherein the 3D image mask analysis method is further applied to the image surveillance apparatus having a stepper motor adapted to control a focusing step of the image receiver, the 3D image mask analysis method further comprises:
the operation processor analyzing a plurality of focusing steps of a plurality of areas divided from the surveillance image; and
the operation processor analyzing related focusing steps of some of the plurality of areas relevant to the 3D image mask for acquiring the first depth information.

4. The 3D image mask analysis method of claim 3, further comprising:
the operation processor computing an object distance of the target object relative to the image surveillance apparatus in accordance with the related focusing steps; and
the operation processor determining coordinate information of the target object within the surveillance image in accordance with the object distance.

5. The 3D image mask analysis method of claim 1, further comprising:
the operation processor acquiring first 3D coordinate information of a cursor located at a first position point and second 3D coordinate information of the cursor located at a second position point within the surveillance image; and
the operation processor replacing second plane coordinate information of the second 3D coordinate information by first plane coordinate information of the first 3D coordinate information when determining the second position point being located directly above the first position point, and then calibrating height coordinate information of the second 3D coordinate information, so as to acquire a calibrated second 3D coordinate information for defining the 3D image mask.

6. The 3D image mask analysis method of claim 1, further comprising:
the operation processor acquiring first 3D coordinate information of a cursor located at a first position point within the surveillance image; and
the operation processor generating a virtual auxiliary line upwardly extended from the first position point for defining the 3D image mask via the virtual auxiliary line;
wherein plane coordinate information of all pixels of the virtual auxiliary line are the same as first plane coordinate information of the first 3D coordinate information.

7. The 3D image mask analysis method of claim 1, further comprising:
the operation processor utilizing the object identification technology to acquire height information of the target object; and
the operation processor determining to display the image of the target object within the surveillance image when a difference between the first depth information and the second depth information is smaller than a depth threshold and the height information is greater than or equal to a height threshold.

8. The 3D image mask analysis method of claim 1, further comprising:
the operation processor further acquiring object coordinate information of several pixels contained by a contour of the target object within the surveillance image; and
the operation processor replacing mask pixel information of the 3D image mask inside object coordinate information by object pixel information of the several pixels of the target object.

9. The 3D image mask analysis method of claim 1, further comprising:
the operation processor setting a first position point of a cursor within the surveillance image as a first corner point of an auxiliary box with a known size, and at least acquiring a second corner point and a third corner point of the auxiliary box; and
the operation processor adjusting coordinate information of the second corner point and/or the third corner point in accordance with an input command, so as to change a coverage range of the auxiliary box for defining the 3D image mask.

10. An image surveillance apparatus, comprising:
an image receiver adapted to acquire a surveillance image; and
an operation processor electrically connected with the image receiver, the operation processor being adapted to set a 3D image mask with first depth information inside the surveillance image, utilize an object identification technology to acquire second depth information of a target object at least partly overlapped with the 3D image mask inside the surveillance image, and compare the first depth information with the second depth information to determine whether an image of the target object is displayed inside the surveillance image in accordance with a comparison result.

11. The image surveillance apparatus of claim 10, wherein the operation processor is adapted to further analyze at least one installation parameter of the image receiver to acquire coordinate information of each pixel within the surveillance image, and analyze some of the coordinate information relevant to the 3D image mask for acquiring the first depth information.

12. The image surveillance apparatus of claim 10, wherein the 3D image mask analysis method is further applied to the image surveillance apparatus having a stepper motor adapted to control a focusing step of the image receiver, and the operation processor is adapted to further analyze a plurality of focusing steps of a plurality of areas divided from the surveillance image, and analyze related focusing steps of some of the plurality of areas relevant to the 3D image mask for acquiring the first depth information.

13. The image surveillance apparatus of claim 12, wherein the operation processor is adapted to further compute an object distance of the target object relative to the image surveillance apparatus in accordance with the related focusing steps, and determine coordinate information of the target object within the surveillance image in accordance with the object distance.

14. The image surveillance apparatus of claim 10, wherein the operation processor is adapted to further acquire first 3D coordinate information of a cursor located at a first position point and second 3D coordinate information of the cursor located at a second position point within the surveillance image, and replace second plane coordinate information of the second 3D coordinate information by first plane coordinate information of the first 3D coordinate information when determining the second position point being located directly above the first position point, and then calibrate height coordinate information of the second 3D coordinate information, so as to acquire a calibrated second 3D coordinate information for defining the 3D image mask.

15. The image surveillance apparatus of claim 10, wherein the operation processor is adapted to further acquire first 3D coordinate information of a cursor located at a first position point within the surveillance image, and generate a virtual auxiliary line upwardly extended from the first position point for defining the 3D image mask via the virtual auxiliary line, plane coordinate information of all pixels of the virtual auxiliary line are the same as first plane coordinate information of the first 3D coordinate information.

16. The image surveillance apparatus of claim 10, wherein the operation processor is adapted to further utilize the object identification technology to acquire height information of the target object, and determine to display the image of the target object within the surveillance image when a difference between the first depth information and the second depth information is smaller than a depth threshold and the height information is greater than or equal to a height threshold.

17. The image surveillance apparatus of claim 10, wherein the operation processor is adapted to further acquire object coordinate information of several pixels contained by a contour of the target object within the surveillance image, and replace mask pixel information of the 3D image mask inside object coordinate information by object pixel information of the several pixels of the target object.

18. The image surveillance apparatus of claim 10, wherein the operation processor is adapted to further set a first position point of a cursor within the surveillance image as a first corner point of an auxiliary box with a known size, and at least acquire a second corner point and a third corner point of the auxiliary box, and adjust coordinate information of the second corner point and/or the third corner point in accordance with an input command, so as to change a coverage range of the auxiliary box for defining the 3D image mask.
